(19) United States
(12) Patent Application Publication
(10) Pub. No.: US 2008/0220120 A1
(43) Pub. Date: Sep. 11, 2008

(54) Multi-flavor chewing gum package system

(76) Inventor: Donavon O. Washington, Detroit, MI (US)

Correspondence Address: The Weintraub Group, P.L.C., Suite 240, 32000 Northwestern Highway, Farmington Hills, MI, 48334, US

(21) Appl. No.: 12/074,909

(22) Filed: Mar. 7, 2008

Related U.S. Application Data
(60) Provisional application No. 60/906,060, filed on Mar. 9, 2007.

(51) Int. Cl. A23G 4/00; B65D 85/00

(52) U.S. Cl. 426/5; 426/106; 426/87

(57) ABSTRACT

A packaging system for chewing gum sticks wherein a plurality of flavors of chewing gum sticks are contained within a single package. Each foil wrapper of each stick is color-coded to correlate to readily identifiable flavor-denoting indicia. Each stick of each flavor is identically color wrapped. An exterior package envelopes all the sticks and bears color indicia corresponding to the flavors of sticks contained therewithin. Optionally, alphabetical indicia are imprinted into the colors of the exterior package to further identify flavors of sticks within the package.

### CROSS-REFERENCE TO RELATED APPLICATION

This application is a completion application of co-pending U.S. Provisional Application No. 60/906,060, filed on Mar. 9, 2007 for “Multi-Flavor Chewing Gum Package System,” the entire disclosure of which is hereby incorporated by reference.

### BACKGROUND OF THE INVENTION

1. Field of the Invention

The present invention pertains to comestible products. More particularly, this invention relates to chewing gum. Even more particularly, the present invention pertains to a packaging method for packaging multi-plural or a variety of flavors of chewing gum in a single package.

2. Description of the Prior Art

As is known to those skilled in the art to which the present invention pertains, chewing gum is dispensed in packages wherein a plurality of chewing gum sticks of the same flavor are contained therewithin. Depending on the desires of the user or consumer if a choice or a selection of chewing gum sticks is desired then a variety of packages must be purchased.

It is apparent that carrying a plurality of packages results in bulk, and inconvenience.

As the present invention will be discussed hereinafter the packaging system hereof alleviates this constraint.

### SUMMARY OF THE INVENTION

In accordance with the present invention there is provided a packaging system for chewing gum sticks wherein a plural or a variety of flavors of chewing gum sticks are contained within a single package. In order to facilitate identification each wrapper of each of the individual sticks is color-coded to correlate to a readily identifiable indicia to denote the flavor of the gum.

In accordance herewith, a variety of flavored gum sticks are stowed in a package, the package containing at least two flavors.

Preferably, a plurality of sticks for each flavor are contained within the package.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view of a chewing gum packaging system in accordance with the present invention.

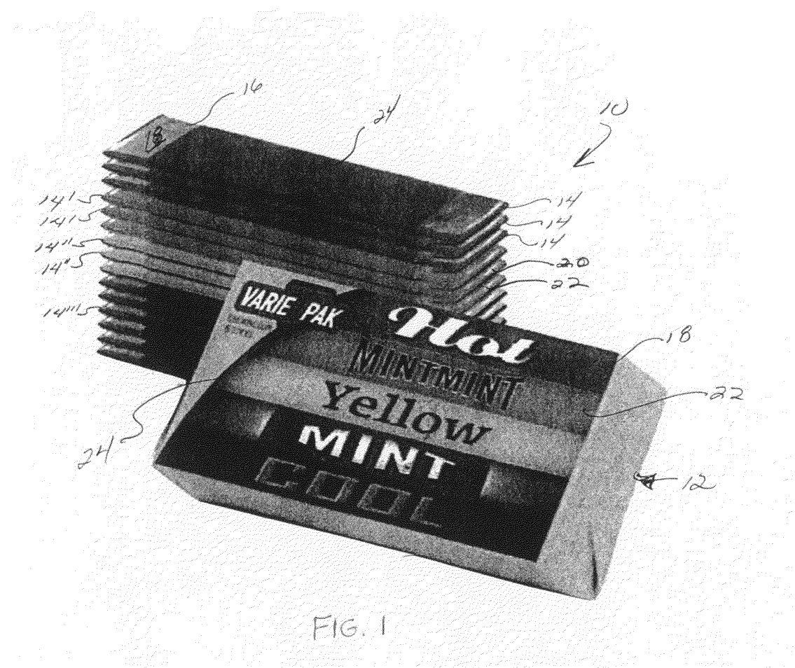

### DETAILED DESCRIPTION OF THE PREFERRED EMBODIMENT

Now, and with reference to the drawing, there is depicted therein a chewing gum stick packaging system in accordance herewith and, generally denoted at 10. The packaging system 10 hereof includes an exterior wrapper 12 which houses at least two chewing gum sticks of different flavors, denoted at 14, 14′, respectively. Optimally, the system hereof comprises a plurality of a first flavor of sticks, each denoted at 14; a plurality of a second flavor of sticks denoted at 14′. Third and fourth flavors of sticks are denoted at 14″ and 14′″, etc. As is known to those skilled in the art to which the present invention pertains, the exterior packaging or wrapper 12 generally, comprises a foil or similar material which is folded to releasably encase the plurality of chewing gum sticks 14, 14′, 14″, etc. therewithin. Herein the size of the wrapper 12 is solely dependent upon the number of chewing gum sticks which are stowed therewithin.

In accordance herewith, and as noted above, there is provided at least a first stick 14 of a first flavor, at least a second stick 14′ of a second flavor, etc. Preferably, and as indicated above, the present invention includes a plurality of sticks 14, a second plurality of sticks 14′, etc. such that there are multiple plural sticks of multiple or a variety of flavors stowed within the wrapper 12.

In order to enable the user to readily identify which flavor of gum is contained within a single stick, each of the sticks 14 of the first flavor are encased within a foil wrapper or similar packages 16 having a first indicia 18. Preferably, the first indicia is a first color.

Similarly, each of the sticks 14′ of the second flavor are wrapped in a foil 20 of a second color 22 dissimilar from the first color. This color association is carried out throughout the packaging for each of the different flavors. Thus, each stick of any one flavor is wrapped in a wrapping of the same color.

Again, as is known to those skilled in the art to which the present invention pertains, the wrapping of a single stick of gum is usually accompanied not only by a foil wrapper but a paper wrapper 24, as well, to maintain the foil in a closed position. It is contemplated that the paper wrapper for each stick would be of the same color as the foil associated with each stick, as shown.

To further implement the present invention it is contemplated, although not essential to the practice of the present invention, that the exterior wrapper 12 also, contain or be provided with color indicia corresponding to the colors of the flavors of the sticks of gum contained therewithin as shown at 18, 22, 24, etc., respectively. Further, as shown in the drawing, the exterior color indicia may be imprinted with an alphabetical display correlating the associated color with the flavor of the chewing gum stick wrapped in the same color foil.

The actual manufacture of the various foil wrappers and the printing thereof is readily achieved by any suitable method well-known and well-identified in the prior art. Colored foils are well known and commercially available. It is understood though that foil wrappers are ordinarily employed in order to impart longevity to the product so that it maintains its freshness and does not become stale.

It is apparent from the preceding that there has been described herein a packaging system for chewing gum sticks which enables the consumer to select any desired flavor in a convenient manner to avoid the need to carry multiple packages of chewing gum sticks.

Having, thus, described the invention, what is claimed is:

1. A multi-flavor chewing gum package system comprising:
at least two chewing gum sticks, each stick being of a different flavor, a foil wrapper for each of the sticks, the wrappers being of different colors such that a foil wrapper for a first flavor stick has a color different from that of the wrapper for a different flavored stick,
an exterior packaging for encasing the at least two sticks, the exterior packaging having color indicia, the color indicia corresponding to the colors of the wrappers of the flavored sticks.

2. The system of claim 1 which further comprises:
a paper wrapper enveloping each of the foil wrappers, each paper wrapper being of the same color as the associated foil wrapper.

3. The system of claim 1 which further comprises:
alphabetical indicia imprinted on the exterior packaging within each color indicia, the alphabetical indicia for identifying the flavors associated with the colors of the wrapper.

4. The system of claim 3 which further comprises:
a first plurality of chewing gum sticks of a first flavor, each of the plurality having its own foil wrapper,
a second plurality of chewing gum sticks of a second flavor, each of the plurality having its own foil wrapper, and
wherein the foil wrapper for each stick of the first flavor is of the same first color and the foil wrapper for each stick of the second plurality is of the same second color, the first and second colors being different from each other.
